(19) United States
(12) Patent Application Publication
(10) Pub. No.: US 2017/0309298 A1
(43) Pub. Date: Oct. 26, 2017

(54) DIGITAL FINGERPRINT INDEXING

(71) Applicant: Gracenote, Inc., Emeryville, CA (US)

(72) Inventors: Jeffrey Scott, Berkeley, CA (US); Markus K. Cremer, Orinda, CA (US); Robert Coover, Orinda, CA (US)

(21) Appl. No.: 15/134,071

(22) Filed: Apr. 20, 2016

(51) Int. Cl. G10L 25/87; G10L 25/54; G10L 19/018

(52) U.S. Cl. CPC G10L 25/87; G10L 19/018; G10L 25/54

(57) ABSTRACT

A machine accesses audio data that may be included in a media item, and the audio data includes multiple segments. The machine detects a silent segment among non-silent segments of the audio data. The machine generates sub-fingerprints of the non-silent segments by hashing the non-silent segments with a same fingerprinting algorithm, but the machine generates a sub-fingerprint of the silent segment based on a predetermined non-zero value that represents fingerprinted silence. With these sub-fingerprints generated, the machine generates a fingerprint of the audio data, of the media item, or of both, by storing the generated sub-fingerprints mapped to locations of their corresponding segments in the audio data. The machine then indexes the fingerprint by indexing the sub-fingerprints of the non-silent segments, without indexing the sub-fingerprint of the silent segment.

### TECHNICAL FIELD

The subject matter disclosed herein generally relates to the technical field of special-purpose machines that facilitate indexing of data, including computerized variants of such special-purpose machines and improvements to such variants, and to the technologies by which such special-purpose machines become improved compared to other special-purpose machines that facilitate indexing of data. Specifically, the present disclosure addresses systems and methods to facilitate indexing of digital fingerprints.

### BACKGROUND

Audio information (e.g., sounds, speech, music, or any suitable combination thereof) may be represented as digital data (e.g., electronic, optical, or any suitable combination thereof). For example, a piece of music, such as a song, may be represented by audio data (e.g., in digital form), and such audio data may be stored, temporarily or permanently, as all or part of a file (e.g., a single-track audio file or a multi-track audio file). In addition, such audio data may be communicated as all or part of a stream of data (e.g., a single-track audio stream or a multi-track audio stream). A machine may be configured to interact with one or more users by accessing a query fingerprint (e.g., generated from an audio piece to be identified), comparing the query fingerprint to a database of reference fingerprints (e.g., generated from previously identified audio pieces), and notifying the one or more users whether the query fingerprint matches any of the reference fingerprints.

### BRIEF DESCRIPTION OF THE DRAWINGS

Some embodiments are illustrated by way of example and not limitation in the figures of the accompanying drawings.

FIG. 1 is a network diagram illustrating a network environment suitable for silence-sensitive indexing of a fingerprint, according to some example embodiments.

FIG. 2 is a block diagram illustrating components of a machine suitable for silence-sensitive indexing of a fingerprint, according to some example embodiments.

FIG. 3 is a block diagram illustrating components of a device suitable for silence-sensitive indexing the fingerprint, according to some example embodiments.

FIG. 4 is a conceptual diagram illustrating reference audio, reference audio data, query audio, and query audio data, according to some example embodiments.

FIG. 5 is a conceptual diagram illustrating a reference fingerprint of a reference media item, the query fingerprint of a query media item, reference sub-fingerprints of respectively corresponding segments of the reference audio data, and query sub-fingerprints of respectively corresponding segments of the query audio data, according to some example embodiments.

FIGS. 6, 7, 8, 9, and 10 are flowcharts illustrating operations in performing a method of indexing a fingerprint in a silence-sensitive manner, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate silence-sensitive indexing of digital fingerprints (hereinafter “fingerprints”), and example systems (e.g., special-purpose machines) are configured to facilitate silence-sensitive indexing of fingerprints. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine (e.g., an audio processing machine) may form all or part of a fingerprinting system (e.g., an audio fingerprinting system), and such a machine may be configured (e.g., by software modules) to index fingerprints based on representations of silence encoded therein. This process is referred to herein as silence-sensitive indexing of fingerprints (e.g., silence-based indexing of audio fingerprints).

As configured, according to various example embodiments, the machine accesses audio data that may be included in a media item (e.g., an audio file, an audio stream, a video file, a video stream, a presentation file, or any suitable combination thereof). The audio data includes multiple segments (e.g., overlapping or non-overlapping). The machine detects a silent segment among non-silent segments, and the machine generates sub-fingerprints of the non-silent segments by hashing the non-silent segments with a same fingerprinting algorithm. However, the machine generates a sub-fingerprint of the silent segment based on (e.g., by inclusion in the generated sub-fingerprint) a predetermined non-zero value that indicates or otherwise represents fingerprinted silence. This approach may be repeated for additional silent segments within the audio data. With such sub-fingerprints generated, the machine generates a fingerprint (e.g., a fingerprint of the audio data, a fingerprint of the media item, or a fingerprint of both) by storing the generated sub-fingerprints assigned (e.g., mapped or otherwise correlated) to locations of their corresponding segments (e.g., silent or non-silent) in the audio data. The machine then indexes the generated fingerprint by indexing the sub-fingerprints of the non-silent segments, without indexing the sub-fingerprint of the silent segment.

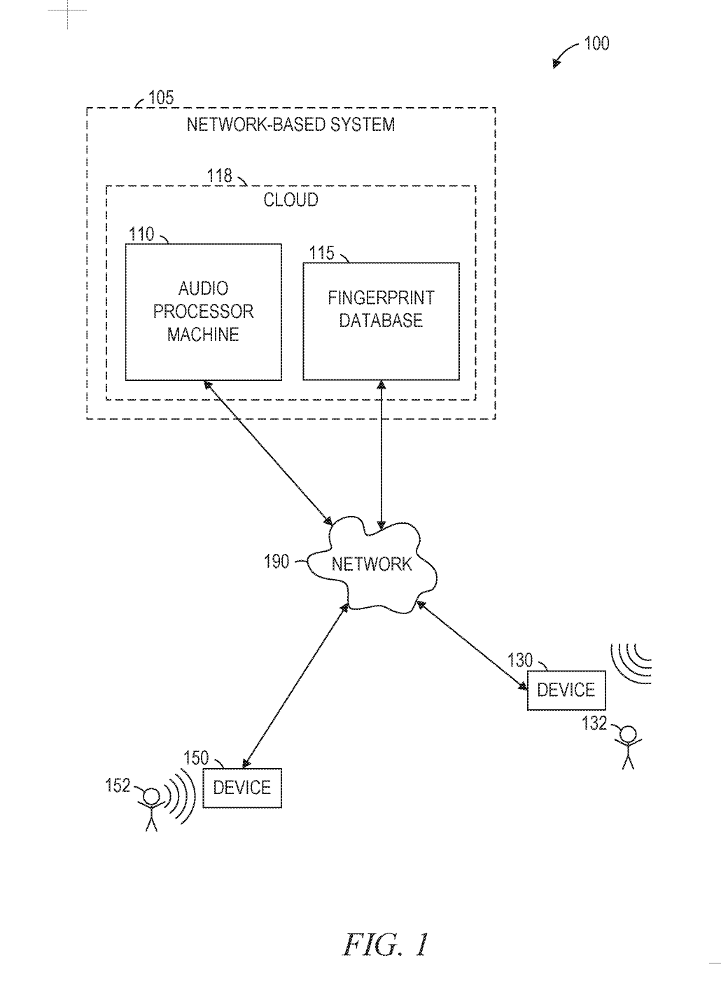

FIG. 1 is a network diagram illustrating a network environment 100 suitable for silence-sensitive indexing of a fingerprint, according to some example embodiments. The network environment 100 includes an audio processor machine 110, a fingerprint database 115, and devices 130 and 150, all communicatively coupled to each other via a network 190. The audio processor machine 110 may be or include a silence detection machine, a fingerprint generation machine (e.g., an audio fingerprinting machine or other media fingerprinting machine), a fingerprint indexing machine, or any suitable combination thereof. The fingerprint database 115 stores one or more fingerprints (e.g., reference fingerprints generated from audio or other media whose identity is known), which may be used for comparison to other fingerprints (e.g., query fingerprints generated from audio or other media to the identified).

One or both of the devices 130 and 150 are shown as being positioned, configured, or otherwise enabled to receive externally generated audio (e.g., sounds) and generate audio data that represents such externally generated audio. One or both of the devices 130 and 150 may be or include a silence detection device, a fingerprint generation device (e.g., an audio fingerprinting device or other media fingerprinting device), a fingerprint indexing device, or any suitable combination thereof.

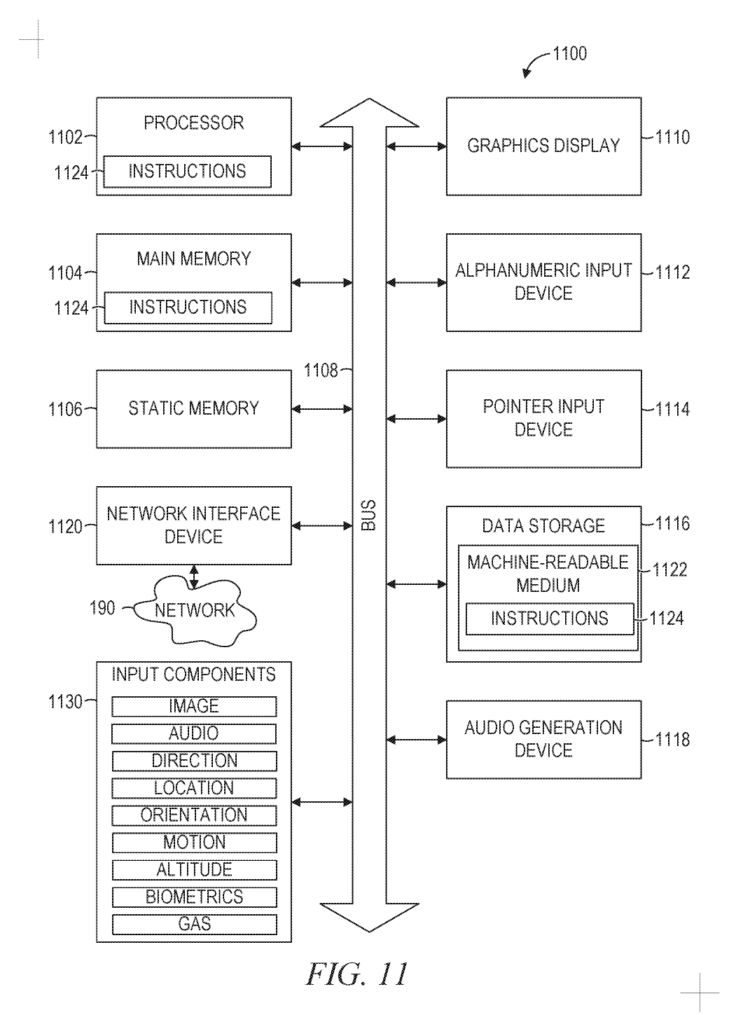

The audio processor machine 110, with or without the fingerprint database 115, may form all or part of a cloud 118 (e.g., a geographically distributed set of multiple machines configured to function as a single server), which may form all or part of a network-based system 105 (e.g., a cloud-based server system configured to provide one or more network-based services to the devices 130 and 150). The audio processor machine 110 and the devices 130 and 150 may each be implemented in a special-purpose (e.g., specialized) computer system, in whole or in part, as described below with respect to FIG. 11.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is associated with the device 130 and may be a user of the device 130. For example, the device 130 may be a desktop computer, a vehicle computer, a tablet computer, a navigational device, a portable media device, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a tablet computer, a navigational device, a portable media device, a smart phone, or a wearable device (e.g., a smart watch, smart glasses, smart clothing, or smart jewelry) belonging to the user 152.

Any of the systems or machines (e.g., databases and devices) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein as discussed below with respect to FIG. 11, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single machine, and the functions described herein for any single system or machine may be subdivided among multiple systems or machines.

The network 190 may be any network that enables communication between or among systems, machines, databases, and devices (e.g., between the machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

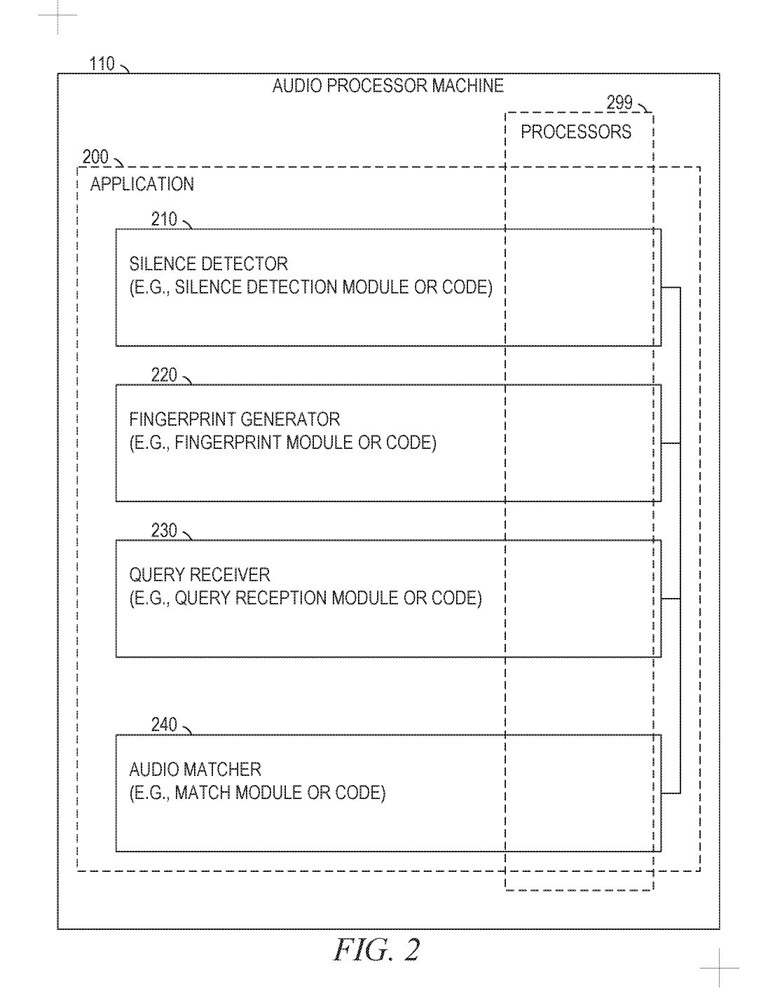

FIG. 2 is a block diagram illustrating components of the audio processor machine 110, according to some example embodiments. The audio processor machine 110 is shown as including a silence detector 210, a fingerprint generator 220, a query receiver 230, and an audio matcher 240, all configured to communicate with each other (e.g., via a bus, shared memory, or a switch). The silence detector 210 may be or include a silence detection module or silence detection software (e.g., instructions or other code). The fingerprint generator 220 may be or include a fingerprint module or fingerprinting software. The query receiver 230 may be or include a query reception module or query reception software. The audio matcher 240 may be or include a match module or audio matching software.

As shown in FIG. 2, the silence detector 210, the fingerprint generator 220, the query receiver 230, and the audio matcher 240 may form all or part of an application 200 that is stored (e.g., installed) on the audio processor machine 110. Furthermore, one or more processors 299 (e.g., hardware processors, digital processors, or any suitable combination thereof) may be included (e.g., temporarily or permanently) in the application 200, the silence detector 210, the fingerprint generator 220, the query receiver 230, the audio matcher 240, or any suitable combination thereof.

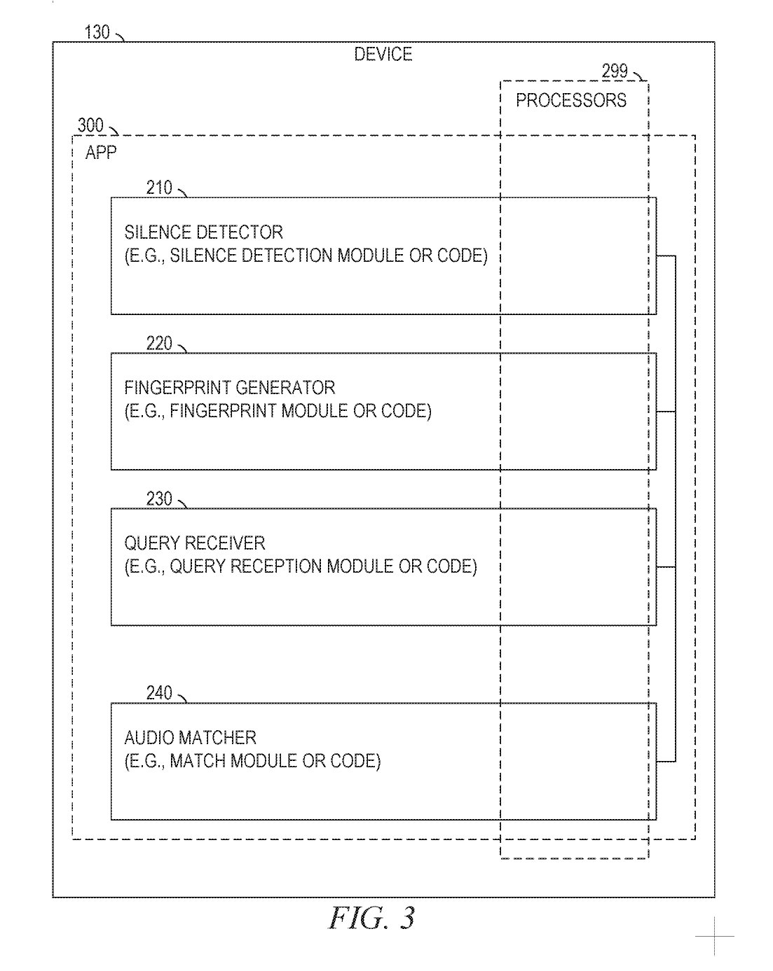

FIG. 3 is a block diagram illustrating components of the device 130, according to some example embodiments. As shown in FIG. 3, any one or more of the silence detector 210, the fingerprint generator 220, the query receiver 230, the audio matcher 240 may be included (e.g., installed) in the device 130 and may be configured to communicate with each other (e.g., via a bus, shared memory, or a switch).

Furthermore, the silence detector 210, the fingerprint generator 220, the query receiver 230, and the audio matcher 240 may form all or part of an app 300 (e.g., a mobile app) that is stored the device 130 (e.g., responsive to or otherwise as a result of data being received from the audio processor machine 110, the fingerprint database 115, or both, via the network 190). As noted above, one or more processors 299 (e.g., hardware processors, digital processors, or any suitable combination thereof) may be included (e.g., temporarily or permanently) in the app 300, the silence detector 210, the fingerprint generator 220, the query receiver 230, the audio matcher 240, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

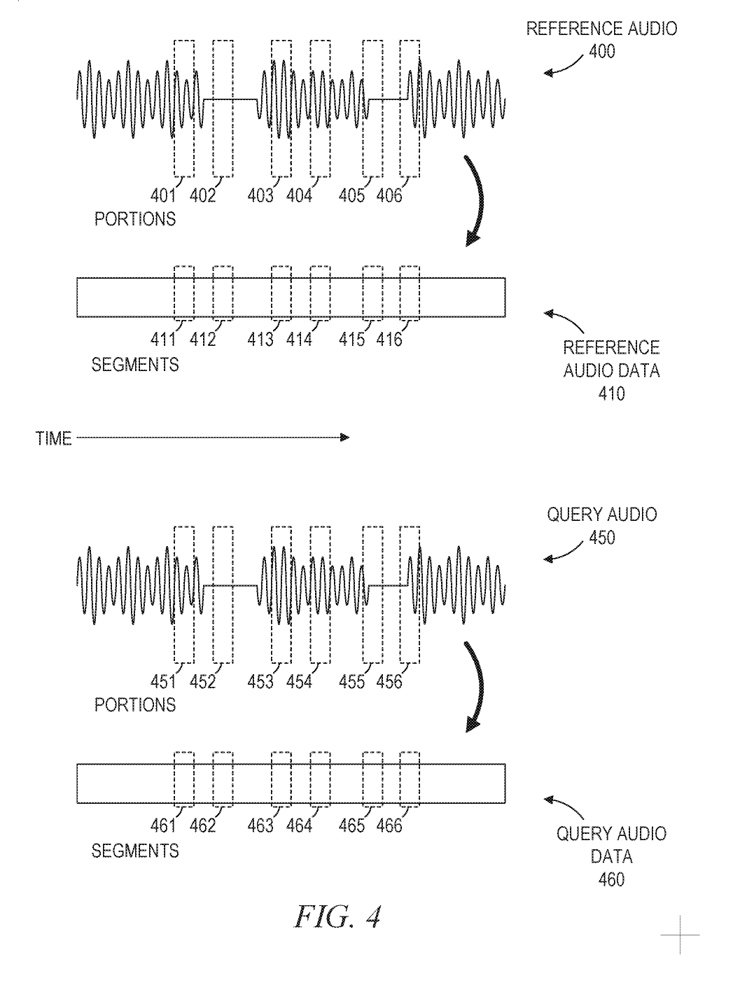

FIG. 4 is a conceptual diagram illustrating reference audio 400, reference audio data 410, query audio 450, and query audio data 460, according to some example embodiments. The reference audio 400 may form all or part of reference media whose identity is already known, and the query audio 450 may form all or part of query media whose identity is not already known (e.g., to be identified by comparison to various reference media). The reference audio 400 is represented (e.g., digitally, within the audio processor machine 110 or the device 130) by the reference audio data 410, and the query audio 450 is represented (e.g., digitally, within the audio processor machine 110 or the device 130) by the query audio data 460.

As shown in FIG. 4, reference portions 401, 402, 403, 404, 405, and 406 of the reference audio 400 are respectively represented (e.g., sampled, encoded, or both) by reference segments 411, 412, 413, 414, 415, and 416 of the reference audio data 410. The reference portions 401-406 may be overlapping (e.g., by five (5) milliseconds or by ten (10) milliseconds) or non-overlapping, according to various example embodiments. In some example embodiments, the reference portions 401-406 have a uniform duration that ranges from ten (10) milliseconds to thirty (30) milliseconds. For example, the reference portions 401-406 may each be twenty (20) milliseconds long. Accordingly, the reference segments 411-416 may be similarly overlapping or non-overlapping, according to various example embodiments, and may have a uniform duration that ranges from ten (10) milliseconds to thirty (30) milliseconds (e.g., twenty (20) milliseconds long).

Similarly, query portions 451, 452, 453, 454, 455, and 456 of the query audio 450 are respectively represented by query segments 461, 462, 463, 464, 465, and 466 of the query audio data 460. The query portions 451-456 may be overlapping (e.g., by five (5) milliseconds or by ten (10) milliseconds) or non-overlapping. In certain example embodiments, the query portions 451-456 have a uniform duration that ranges from ten (10) milliseconds to thirty (30) milliseconds. For example, the query portions 451-456 may each be twenty (20) milliseconds long. Accordingly, the query segments for 61-466 may be similarly overlapping or non-overlapping, according to various example embodiments, and may have a uniform duration that ranges from ten (10) milliseconds to thirty (30) milliseconds (e.g., twenty (20) milliseconds long).

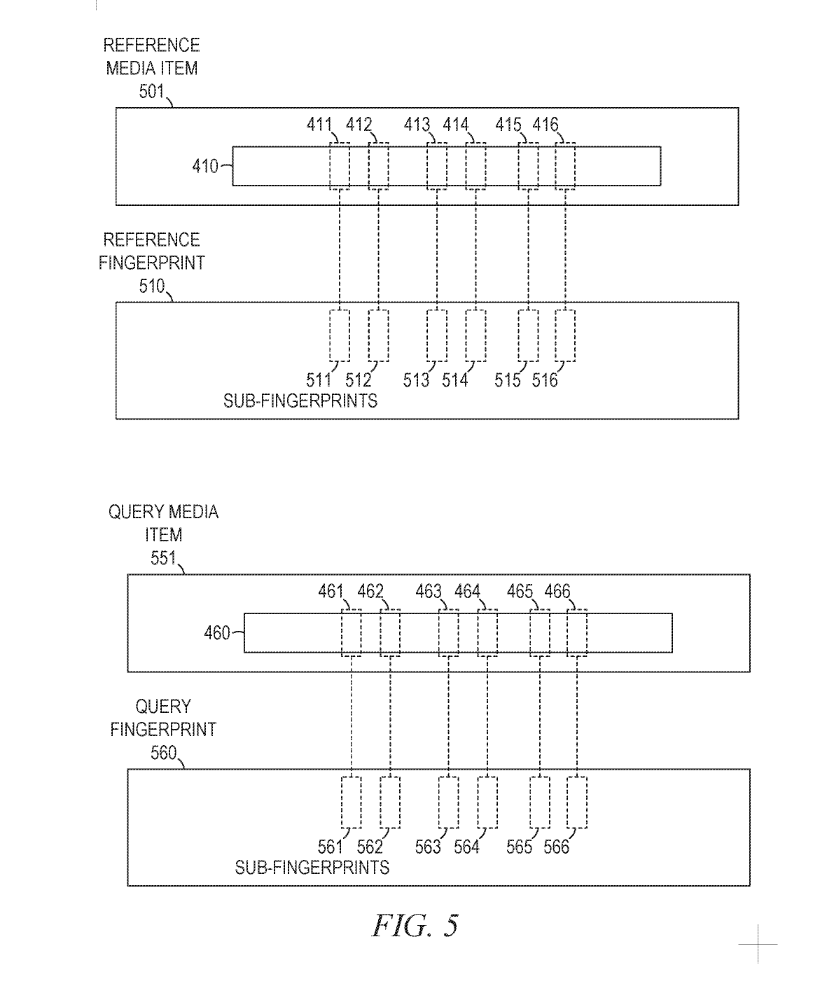

FIG. 5 is a conceptual diagram illustrating a reference fingerprint 510 of a reference media item 501, a query fingerprint 560 of a query media item 551, respective reference sub-fingerprints 511, 512, 513, 514, 515, and 516 of the reference segments 411, 412, 413, 414, 415, and 416 of the reference audio data 410, and respective query sub-fingerprints 561, 562, 563, 564, 565, and 566 of the query segments 461, 462, 463, 464, 465, and 466 of the query audio data 460, according to some example embodiments. That is, the reference sub-fingerprint 511 is generated based on the reference segment 411 and may be used to identify or represent the reference segment 411; the reference sub-fingerprint 512 is generated based on the reference segment 412 and may be used to identify or represent the reference segment 412; and so on, as illustrated in FIG. 5. Similarly, the query sub-fingerprint 561 is generated based on the query segment 461 and may be used to identify or represent the query segment 461; the query sub-fingerprint 562 is generated based on the query segment 462 and may be used to identify or represent the query segment 462; and so on, as illustrated in FIG. 5.

The reference sub-fingerprints 511-516 may form all or part of the reference fingerprint 510. Accordingly, the reference fingerprint 510 is generated based on the reference media item 501 (e.g., generated based on the reference audio data 410) and may be used to identify or represent the reference media item 501. Likewise, the query sub-fingerprints 561-566 may form all or part of the query fingerprint 560. Thus, the query fingerprint 560 is generated based on the query media item 551 (e.g., generated based on the query audio data 460) and may be used to identify or represent the query media item 551.

The reference portions 401-406 of the reference audio 400 may each contain silence or non-silence. That is, each of the reference portions 401-406 may be a silent portion or a non-silent portion (e.g., as determined by comparison of its loudness to a predetermined threshold percentage of an average or peak sound level for the reference audio 400). Accordingly, each of the reference segments 411-416 may be a silent segment or a non-silent segment. Similarly, the query portions 451-456 may each contain silence or non-silence. In other words, each of the query portions 451-456 may be a silent portion or a non-silent portion (e.g., as determined by comparison of its loudness to a predetermined threshold percentage of an average sound level or a peak sound level for the query audio 450). Hence, each of the query segments 461-466 may be a silent segment or a non-silent segment.

For purposes of clear illustration, the example embodiments described herein are discussed with respect to an example scenario in which the reference segments 411, 412, 414, 415, and 416 are non-silent segments of the reference audio data 410; the reference segment 413 is a silent segment of the reference audio data 410; the query segments 461, 462, 464, 465, and 466 are non-silent segments of the query audio data 460; and the query segment 463 is a silent segment of the query audio data 460. Accordingly, the reference sub-fingerprints 511, 512, 514, 515, and 516 and the query sub-fingerprints 561, 562, 564, 565, at 566 can be referred to as non-silent sub-fingerprints, while the reference sub-fingerprint 513 and the query sub-fingerprint 563 can be referred to as silent sub-fingerprints.

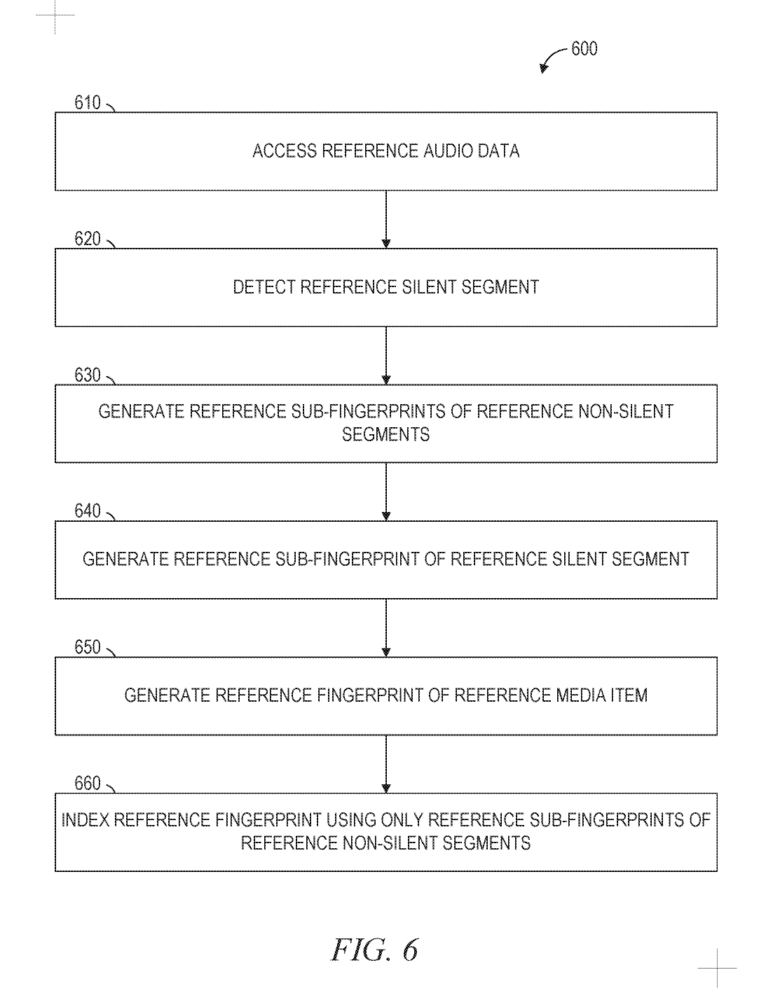

FIG. 6-10 are flowcharts illustrating operations in performing a method 600 of indexing a fingerprint (e.g., audio fingerprint) in a silence-sensitive manner, according to some example embodiments. Operations in the method 600 may be performed by the audio processor machine 110, by the device 130, or by a combination of both, using components (e.g., modules) described above with respect to FIGS. 2 and 3, using one or more processors 299 (e.g., microprocessors or other hardware processors), or using any suitable combination thereof. As shown in FIG. 6, the method 600 includes operations 610, 620, 630, 640, 650, and 660. Although the following discussion of the method 600 refers to the reference audio data 410 for purposes of clarity, according to various example embodiments, the query audio data 460 may be treated in a similar manner.

In operation 610, the silence detector 210 accesses the reference audio data 410 included in the reference media item 501. The reference audio data 410 may be stored by the fingerprint database 115, the audio processor machine 110, the device 130, or any suitable combination thereof, and accordingly accessed therefrom.

In operation 620, the silence detector 210 detects a silent segment (e.g., reference segment 413) among the reference segments 411-416 of the reference audio data 410 accessed in operation 610. As noted above, the reference segments 411-416 may include non-silent segments (e.g., reference segments 411, 412, 414, 415, and 416) in addition to one or more silent segments (e.g., reference segment 413). Thus, in performing operation 620, the silence detector 210 may detect the reference segment 413 as a silent segment of the reference audio data 410. Conversely, the silence detector 210 may also detect the reference segments 411, 412, 414, 415, and 416 as non-silent segments of the reference audio data 410.

In operation 630, the fingerprint generator 220 generates the reference sub-fingerprints 511, 512, 514, 515, and 516 of the non-silent segments (e.g., reference segments 411, 412, 414, 415, and 416) of the reference audio data 410 accessed in operation 610. This is performed by hashing the non-silent segments with a same fingerprinting algorithm (e.g., a single fingerprinting algorithm for hashing all of the non-silent segments). Accordingly, in performing operation 630, the fingerprint generator 220 may hash each of the reference segments 411, 412, 414, 415, and 416 with the same fingerprinting algorithm to obtain the reference sub-fingerprints 511, 512, 514, 515, and 516 respectively.

In some example embodiments, portions of operations 620 and 630 are interleaved such that the silence detector 210, in performing operation 620, takes its input from the fingerprint generator 220 by using the results of an interim processing step within operation 630. For example, the fingerprint generator 220 may process different frequency bands differently such that one or more particular frequency bands may be weighted for emphasis (e.g., exclusively used) in determining whether a segment is to be classified as silent or non-silent. This may provide the benefit of allowing the silence detector 210 to determine the presence or absence of silence based on the same interim data used by fingerprint generator 220. Accordingly, the same frequency bands used by the fingerprint generator 220 in performing operation 630 may be used by the silence detector 210 in performing operation 620, or vice versa.

In operation 640, the fingerprint generator 220 generates the reference sub-fingerprint 513 of the silent segment (e.g., reference segment 413) detected in operation 620. This is performed by using a predetermined non-zero value numerical value) that indicates fingerprinted silence and incorporating the predetermined non-zero value into the generated reference sub-fingerprint 513 of the silent segment (e.g., reference segment 413). In some example embodiments, one or more repeated instances of the predetermined non-zero value form the entirety of the generated reference sub-fingerprint 513 of the silent segment. In other example embodiments, one or more repeated instances of the predetermined non-zero value form only a portion of the generated reference sub-fingerprint 513 of the silent segment. Hence, in performing operation 640, the fingerprint generator 220 may iteratively write the predetermined non-zero value one or more times into the reference sub-fingerprint 513, based on (e.g., in response to) the fact that the reference segment 413 was detected as a silent segment in operation 620.

In operation 650, the fingerprint generator 220 generates the reference fingerprints 510 of the referenced media item 501 whose reference audio data 410 was accessed in operation 610. This may be performed by storing the reference sub-fingerprints 511-516 generated in operations 630 and 640, each mapped to the corresponding location of its corresponding segment in the reference audio data 410. Thus, in performing operation 650, the fingerprint generator 220 may generate the reference fingerprint 510 by storing the reference sub-fingerprints 511-516 (e.g., in the fingerprint database 115), each with a corresponding mapping or other reference to the corresponding location of the corresponding reference segment (e.g., to the reference segment 411, 412, 413, 414, 415, or 416) in the reference audio data 410. Accordingly, if the reference segment 413 was detected as a silent segment, the sub-fingerprint 513 is mapped to the location of its corresponding reference segment 413 within the reference audio data 410.

In operation 660, the fingerprint generator 220 indexes the reference fingerprint 510 (e.g., within the fingerprint database 115) using only sub-fingerprints (e.g., reference sub-fingerprints 511, 512, 514, 515, and 516) of non-silent segments (e.g., reference segments 411, 412, 414, 415, and 416) of the reference audio data 410, without using any sub-fingerprints (e.g., reference sub-fingerprint 513) of silent segments (e.g., reference segment 413) of the reference audio data 410. This may be performed by indexing only the generated sub-fingerprints of the non-silent segments (e.g., indexing the reference sub-fingerprints 511, 512, 514, 515, and 516) and omitting any generated sub-fingerprints of silent segments from the indexing (e.g., omitting the reference sub-fingerprint 513 from the indexing). As an example result, if the reference segment 413 was detected as a silent segment, the sub-fingerprint 513 of the reference segment 413 is not indexed in the indexing of the reference fingerprint 510, while the reference sub-fingerprints 511, 512, 514, 515, and 516 are indexed in the indexing of the reference fingerprint 510.

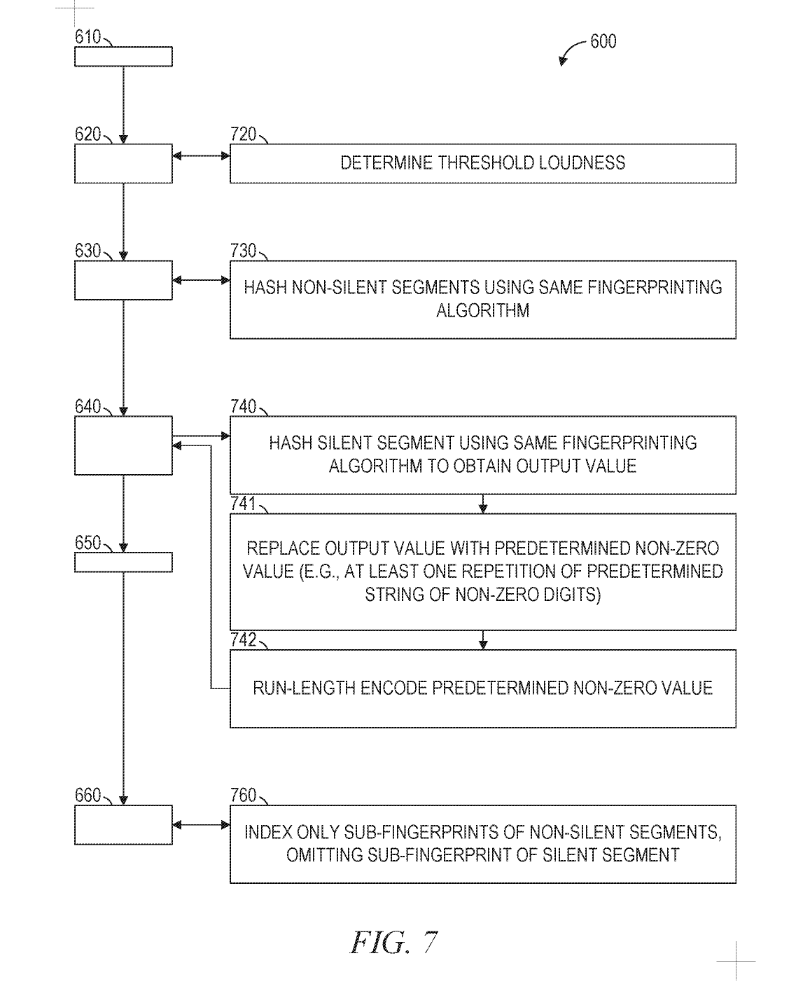

As shown in FIG. 7, in addition to any one or more of the operations previously described, the method 600 may include one or more of operations 720, 730, 740, 741, 742, and 760. Operation 720 may be performed as part (e.g., a precursor task, a subroutine, or a portion) of operation 620, in which the silence detector 210 detects a silent segment (e.g., reference segment 413) among the reference segments 411-416 of the reference audio data 410. In operation 720, the silence detector 210 determines a threshold loudness (e.g., a threshold loudness value, such as a threshold sound volume or a threshold sound level) for comparison to the respective loudness (e.g., loudness values) of the reference segments 411-416 of the reference audio data 410. For example, the silence detector 210 may calculate an average loudness (e.g., average loudness value) for the entirety of the reference audio data 410 and then calculate the threshold loudness as a percentage (e.g., 3%, 5%, 10%, or 15%) of the average loudness. Accordingly, in performing operation 620, the silence detector 210 may detect or otherwise determine that the reference segment 413 has a loudness that fails to exceed the determined threshold loudness, while the reference segments 411, 412, 414, 415, and 416 each have loudness that exceeds the determined threshold loudness, thus resulting in the reference segment 413 being detected as a silent segment and the reference segments 411, 412, 414, 415, and 416 being detected as non-silent segments of the reference audio data 410.

In some example embodiments, the silence detector 210 determines the threshold loudness based on one or more machine-learning techniques to train the silence detector 210. Such training may be based on results of one or more attempts at recognizing audio (e.g., performed by the audio processing machine 110 and submitted by the audio processing machine 110 to one or more users 132 and 152 for verification). Accordingly, in such example embodiments, the silence detector 210 can be trained to recognize when audio segments contain insufficient information for audio recognition; such a segments can then be treated as silent segments (e.g., for the purpose of digital fingerprint indexing). This kind of machine-learning can be improved by preprocessing the training content such that the training content is as unique as possible. Such preprocessing may provide the benefit of reducing the likelihood that the audio processor machine 110 accidentally becomes trained to ignore valid but frequently occurring content, such as a commonly used sound sample (e.g., in a frequently occurring advertisement).

Operation 730 may be performed as part of operation 630, in which the fingerprint generator 220 generates the reference sub-fingerprints 511, 512, 514, 515, and 516 of the non-silent segments of the reference audio data 410. In operation 730, the fingerprint generator 220 hashes each of the non-silent segments (e.g., reference segments 411, 412, 414, 415, and 416) using a same (e.g., single, shared in common) fingerprinting algorithm for each hashing. Accordingly, the fingerprint generator 220 may apply the same fingerprinting algorithm to generate hashes of the reference segments 411, 412, 414, 415, and 416 as the sub fingerprints 511, 512, 514, 515, and 516 respectively.

One or more of operations 740, 741, and 742 may be performed as part of operation 640, in which the fingerprint generator 220 generates the reference sub-fingerprint 513 of the silent segment (e.g., reference segment 413) detected in operation 620. In operation 740, the fingerprint generator 220 hashes the silent segment (e.g., reference segment 413) using the same fingerprinting algorithm that was used in operation 730 to hash the non-silent segments reference segments 411, 412, 414, 415, and 416). The result of this hashing is an output value that can be referred to as a hash of the silent segment (e.g., reference segment 413).

In operation 741, the fingerprint generator 220 replaces the output value from operation 740 with one or more instances (e.g., repetitions) of the predetermined non-zero value (e.g., a predetermined string of non-zero digits) that indicates fingerprinted silence (e.g., a fingerprint or sub-fingerprint of silence in one of the portions 401-406 of the reference audio 400). Accordingly, the predetermined non-zero value is used as a substitute for the hash of the silent segment (e.g., reference segment 413). In some example embodiments, operation 740 is omitted, and operation 741 is performed by directly incorporating (e.g., inserting, or otherwise writing) the one or more instances of the predetermined non-zero value into all or part of the reference sub-fingerprint 513 that is being generated by performance of operation 640.

In operation 742, the fingerprint generator 220 run-length encodes multiple instances of the predetermined non-zero value from operation 741. This may have the effect of reducing the memory footprint of the generated sub-fingerprint 513 of the silent segment (e.g., reference segment 413). In certain example embodiments, however, operation 742 is omitted and no run-length encoding is performed on the predetermined non-zero value within the sub-fingerprint 513.

Operation 760 may be performed as part of operation 660, in which the fingerprint generator 220 indexes the reference fingerprint 510. In operation 760, the fingerprint generator 220 executes an indexing algorithm that indexes only the sub-fingerprints 511, 512, 514, 515, and 516, which respectively correspond to the non-silent reference segments 411, 412, 414, 415, and 416 of the reference audio data 410. This indexing algorithm omits the sub-fingerprint 513 of the silent reference segment 413 from the indexing. For example, the fingerprint generator 220 may queue all of the sub-fingerprints 511-516 for indexing and then delete the sub-fingerprint 513 from the queue, such that the indexing avoids processing the sub-fingerprint 513.

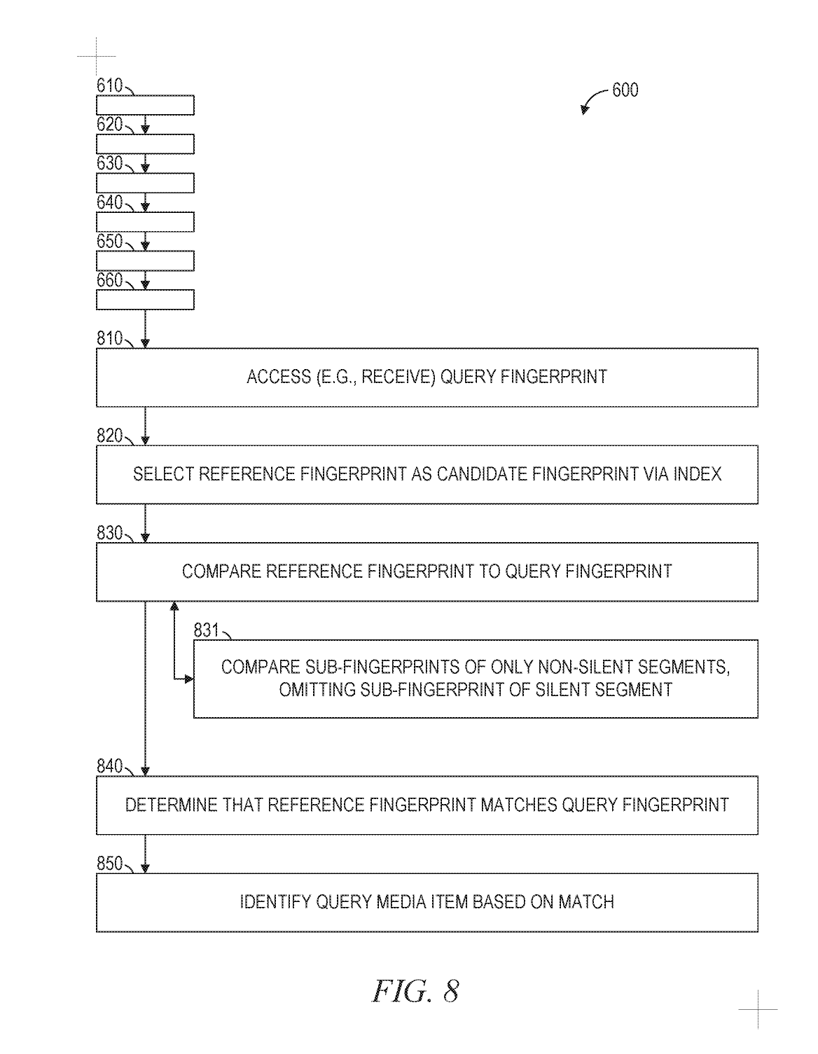

As shown in FIG. 8, in addition to any one or more the operations previously described, the method 600 may include one or more of operations 810, 820, 830, 831, 840, and 850, any one or more of which may be performed after operation 660, in which the fingerprint generator 220 indexes the reference fingerprint 510 (e.g., within an index of fingerprints in the fingerprint database 115). One or more of operations 810-850 may be performed to identify the query media item 551.

In operation 810, the query receiver 230 accesses the query fingerprint 560 (e.g., by receiving the query fingerprint 560 from one of the devices 130 or 150). The query fingerprint 560 may be accessed (e.g., received) as part of receiving a request to identify an unknown media item (e.g., query media item 551).

In operation 820, the audio matcher 240 selects one or more fingerprints as candidate fingerprints for matching against the query fingerprint 560 accessed in operation 810. This may be accomplished by accessing an index of fingerprints in the fingerprint database 115, which may index the reference fingerprints 510 as a result of operation 660. Accordingly, the audio matcher 240 may select the reference fingerprint 510 as a candidate fingerprint for comparison to the query fingerprint 560.

In operation 830, the audio matcher 240 compares the selected reference fingerprint 510 to the accessed query fingerprint 560. This comparison may include comparing one or more of the reference sub-fingerprints 511-516 to one or more of the query sub fingerprints 561-566.

As shown in FIG. 8, operation 831 may be performed as part of operation 830. In operation 831, the audio matcher 240 limits its comparisons of sub-fingerprints to only comparisons of non-silent sub-fingerprints to other non-silent sub-fingerprints, omitting any comparisons that involve silent sub-fingerprints. That is, the audio matcher 240 may compare one or more of the reference sub-fingerprints 511, 512, 514, 550, and 516 to one or more of the query sub-fingerprints 561, 562, 564, 565, and 566, and avoid or otherwise omit any comparison that involves the reference sub-fingerprint 513 or the query sub-fingerprint 563.

In operation 840, the audio matcher 240 determines that the selected reference fingerprint 510 matches the accessed query fingerprint 560. This determination is based on the comparison of the reference fingerprint 510 to the query fingerprint 560, as performed in operation 830.

In operation 850, the audio matcher 240 identifies the query media item 551 based on the results of operation 840. For example, the audio matcher 240 may identify the query media item 551 in response to the determination that the reference fingerprint 510 of the known referenced media item 501 is a match with the query fingerprint 560 of the unknown query media item 551 to be identified.

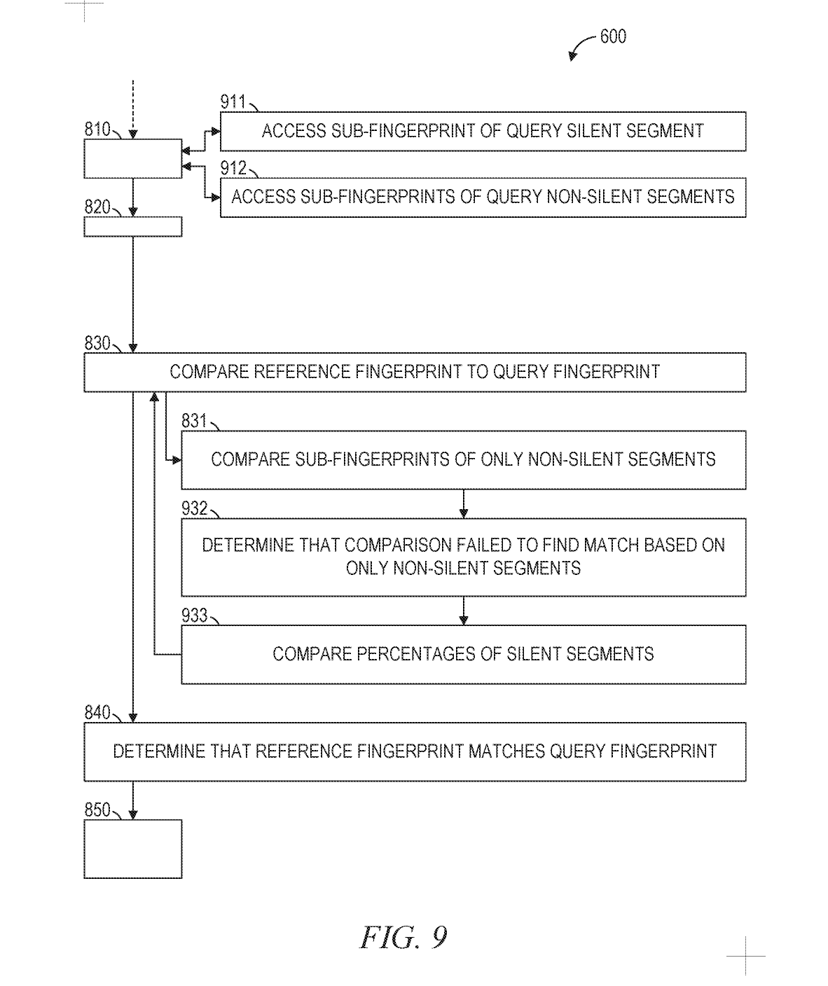

As shown in FIG. 9, in addition to one or more of the operations previously described, the method 600 may include one or more of operations 911, 912, 932, and 933. According to various example embodiments, one or both of operations 911 and 912 may be performed as part of operation 810, in which the query receiver 230 accesses the query fingerprint 560.

In some example embodiments, silent sub-fingerprints of silent segments are used for matching fingerprints, and accordingly, in operation 911, the query receiver 230 accesses silent sub-fingerprints (e.g., query sub-fingerprint 563) in the query fingerprint 560. According to certain variants of such example embodiments, only silent sub-fingerprints are used. As one example, the comparing of the reference fingerprint 510 to the query fingerprint 560 in operation 830 may be performed by comparing the silent reference sub-fingerprint 513 to the silent query sub-fingerprint 563, and the determining that the reference fingerprint 510 matches the query fingerprint 560 in operation 840 may be based on the comparing of the silent reference sub-fingerprint 513 to the silent query sub-fingerprint 563.

In certain example embodiments, non-silent sub-fingerprints of non-silent segments are used for matching fingerprints, and accordingly, in operation 912, the query receiver 230 accesses non-silent sub-fingerprints (e.g., query sub-fingerprints 561, 562, 564, 565, and 566) in the query fingerprint 560. According to some variants of such example embodiments, only non-silent sub-fingerprints are used.

In hybrid example embodiments, both silent and non-silent sub-fingerprints are used, and accordingly, both of operations 911 and 912 are performed. According to such hybrid example embodiments, both silent and non-silent sub-fingerprints (e.g., query sub-fingerprints 561-566) are accessed and available for matching fingerprints.

According to some example embodiments, a failover feature is provided by the audio matcher 240, such that only non-silent sub-fingerprints of non-silent segments are first used in attempting to match fingerprints, but after failing to find a match, silent sub-fingerprints of silent segments are then used. As discussed above, in example embodiments that include operation 831, the audio matcher 240 performs operation 831 by comparing only non-silent sub-fingerprints (e.g., query sub-fingerprints 561, 562, 564, 565, and 566).

As shown in FIG. 9, in operation 932, the audio matcher 240 determines that the comparison performed in operation 831 failed to find a match based on only non-silent sub-fingerprints of non-silent segments (e.g., query segments 461, 462, 464, 465, and 466). In some variants of example embodiments that include operation 932, the comparing of the reference fingerprint 510 to the query fingerprint 560 in operation 830 may then be performed by comparing the silent reference sub-fingerprint 513 to the silent query sub-fingerprint 563, and the determining that the reference fingerprint 510 matches the query fingerprint 560 in operation 840 may be based on the comparing of the silent reference sub-fingerprint 513 to the silent query sub-fingerprint 563.

In other variants of example embodiments that include operation 932, proportions (e.g., percentages) of silent sub-fingerprints, silent segments, or both, are compared in operation 933. For example, in performing operation 933, the audio matcher 240 may compare a query percentage (e.g., 23% or 37%) of silent query sub-fingerprints in the query fingerprint 560 to a reference percentage (e.g., 23% or 36%) of silent reference sub-fingerprints in the reference fingerprint 510. Hence, the comparing of the reference fingerprint 510 to the query fingerprint 560 in operation 830 may be based on this comparison of percentages, and the determining that the reference fingerprint 510 matches the query fingerprint 560 in operation 840 may be based on this comparison as well.

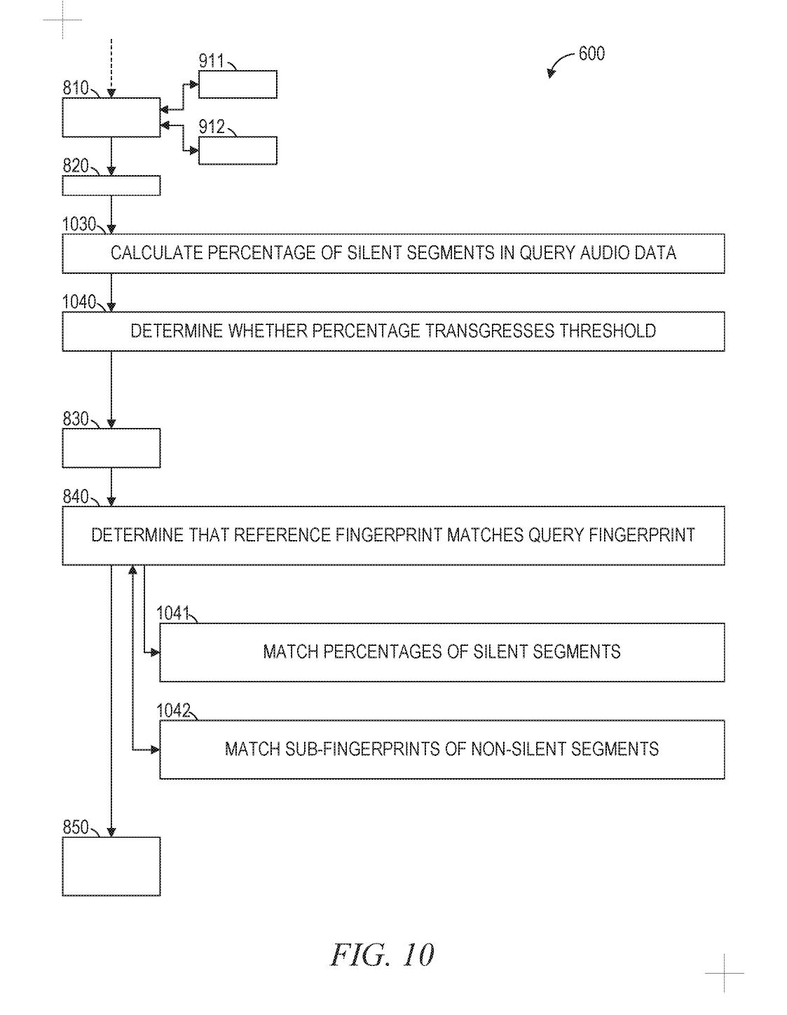

As shown in FIG. 10, in addition to one or more of the operations previously described, the method 600 may include one or more of operations 1030, 1040, 1041, and 1042. In operation 1030, the audio matcher 240 calculates the query percentage of query silent sub-fingerprints (e.g., query sub-fingerprint 563) in the query fingerprint 560. This is the same as calculating a query percentage of query silent segments (e.g., query segment 463) in the query audio data 460.

In operation 1040, the audio matcher 240 determines whether the query percentage of query silent sub-fingerprints transgresses a predetermined threshold percentage of silent segments (e.g., 10%, 15%, or 25%). Based on this determination, the audio matcher 240 may automatically choose whether silent segments or sub-fingerprints thereof will be included in the comparison of the reference fingerprint 510 to the query fingerprint 560 in operation 830. For example, if the audio matcher 240 determines that the calculated percentage of query silent segments transgresses (e.g., exceeds) the predetermined threshold percentage of silent segments, the audio matcher 240 may respond by incorporating operation 933 into its performance of operation 830.

Furthermore, according to various example embodiments, the audio matcher 240 may automatically incorporate one or both of operations 1041 and 1042 into operation 840, in which the audio matcher 240 determines that the reference fingerprint 510 matches the query fingerprint 560. In operation 1041, the audio matcher 240, having compared percentages of silent segments or sub-fingerprints thereof in operation 830, determines that the query percentage matches the reference percentage. In operation 1042, the audio matcher 240, having compared sub-fingerprints of non-silent segments in operation 830 (e.g., by performance of operation 831 or a similar operation), determines that the non-silent sub-fingerprints match (e.g., that non-silent reference sub-fingerprints 511, 512, 514, 515, and 516 match the non-silent query sub-fingerprints 561, 562, 564, 565, and 566).

Accordingly, four general types of situations can be described. In the first type of situation, the query audio 450 has a high proportion of silence, and the audio matcher 240 is configured to find matching fingerprints by comparing proportional silence. Thus, the predetermined threshold percentage of query silent sub-fingerprints (e.g., predetermined threshold percentage of query silent segments) may be a maximum percentage (e.g., ceiling percentage). In response to performance of operation 1040 determining that the query percentage exceeds the maximum percentage, the audio matcher 240 may cause operation 933 to be performed, as described above. In many cases, this is sufficient to determine that the reference fingerprint 510 matches the query fingerprint 560.

In the second type of situation, the query audio 450 has a high proportion of silence, and the audio matcher 240 is configured to find matching fingerprints by matching non-silent segments or sub-fingerprints thereof. Thus, the predetermined threshold percentage of query silent sub-fingerprints may again be a maximum percentage. However, in response to performance of operation 1040 determining that the query percentage exceeds the maximum percentage, the audio matcher 240 may cause operation 831 to be performed, as described above. In many cases, this is sufficient to determine that the reference fingerprint 510 matches the query fingerprint 560.

In the third type of situation, the query audio 450 has a low proportion of silence, and the audio matcher 240 is configured to find matching fingerprints by comparing proportional silence. Hence, the predetermined threshold percentage of query silent sub-fingerprints may be a minimum percentage (e.g., floor percentage). In response to performance of operation 1040 determining that the query percentage fails to exceed the minimum percentage, the audio matcher 240 may cause operation 933 to be performed, as described above. In many cases, this is sufficient to determine that the reference fingerprint 510 matches the query fingerprint 560.

In the fourth type of situation, the query audio 450 has a low proportion of silence, and audio matcher 240 is configured to find matching fingerprints by matching non-silent segments or sub-fingerprints thereof. Hence, the predetermined threshold percentage of query silent sub-fingerprints may again be a minimum percentage. However, in response to performance of operation 1040 determining that the query percentage fails to exceed the minimum percentage, the audio matcher 240 may cause operation 831 to be performed, as described above. In many cases, this is sufficient to determine that the reference fingerprint 510 matches the query fingerprint 560.

According to various example embodiments, one or more of the methodologies described herein may facilitate detection of silent segments in audio data and silence-sensitive indexing of one or more audio fingerprints that contain silent segments. Moreover, one or more of the methodologies described herein may facilitate silence-sensitive processing of queries to identify unknown audio data or other media content. Hence, one or more of the methodologies described herein may facilitate fast and accurate fingerprinting of media items, as well as similarly efficient identification of unknown media items.

When these effects are considered in aggregate, one or more of the methodologies described herein may obviate a need for certain efforts or resources that otherwise would be involved in these or similar audio processing tasks. Efforts expended by a user in performing a search to identify an unknown media item may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be communicatively coupled (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 1104, and a static memory 1106, which are configured to communicate with each other via a bus 1108. The processor 1102 contains solid-state digital microcircuits (e.g., electronic, optical, or both) that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein. In some example embodiments, the processor 1102 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1100 with at least the processor 1102, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a pointer input device 1114 (e.g., a mouse, a touchpad, a touchscreen, a trackball, a joystick, a stylus, a motion sensor, an eye tracking device, a data glove, or other pointing instrument), a data storage 1116, an audio generation device 1118 (e.g., a sound card, an amplifier, a speaker, a headphone jack, or any suitable combination thereof), and a network interface device 1120.

The data storage 1116 (e.g., a data storage device) includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the static memory 1106, within the processor 1102 (e.g., within the processor's cache memory), or any suitable combination thereof before or during execution thereof by the machine 1100. Accordingly, the main memory 1104, the static memory 1506, and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device (e.g., a smart phone, a tablet computer, or a wearable device), and may have one or more additional input components 1130 (e.g., sensors or gauges). Examples of such input components 1130 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1124 for execution by the machine 1100 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1124).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems machines, devices, or other apparatus) discussed herein.

A first embodiment provides a method comprising:

accessing, by one or more processors, audio data included in a media item;
detecting, by the one or more processors, a silent segment among segments of the audio data, the segments of the audio data including non-silent segments in addition to the silent segment;
generating, by the one or more processors, sub-fingerprints of the non-silent segments of the audio data by hashing the non-silent segments with a hashing algorithm (e.g., a fingerprinting algorithm);
generating, by the one or more processors, a sub-fingerprint of the silent segment, the sub-fingerprint of the silent segment including a predetermined non-zero value that indicates fingerprinted silence;
generating, by the one or more processors, a fingerprint of the media item by storing the generated sub-fingerprints mapped to locations of their corresponding segments in the audio data, the generated sub-fingerprint of the silent segment being mapped to a location of the silent segment in the audio data; and
indexing, by the one or more processors, the fingerprint of the media item by indexing the generated sub-fingerprints of the non-silent segments of the audio data without indexing the generated sub-fingerprint of the silent segment of the audio data.

A second embodiment provides a method according to the first embodiment, wherein:

the indexing of the fingerprint of the media item indexes only the generated sub-fingerprints of the non-silent segments and omits the generated sub-fingerprint of the silent segment from the indexing.

A third embodiment provides a method according to the first embodiment or the second embodiment, wherein:

the generating of the sub-fingerprint of the silent segment includes hashing the silent segment with the hashing algorithm used to hash the non-silent segments, the hashing of the silent segment resulting in an output value; and
replacing the output value from the hashing of the silent segment with the predetermined non-zero value that indicates fingerprinted silence.

A fourth embodiment provides a method according to the third embodiment, wherein:

the replacing of the output value with the predetermined non-zero value replaces the output value with one or more repetitions of a predetermined string of non-zero digits, the predetermined string of non-zero digits representing fingerprinted silence.

A fifth embodiment provides a method according to the fourth embodiment, wherein:

the replacing of the output value with the predetermined non-zero value includes run-length encoding the one or more repetitions of the predetermined string of non-zero digits.

A sixth embodiment provides a method according to any of the first through fifth embodiments, wherein:

the fingerprint of the media item is a reference fingerprint of a reference media item; and the method further comprises:
comparing the reference fingerprint to a query fingerprint of a query media item by comparing one or more sub-fingerprints of only the non-silent segments to one or more sub-fingerprints generated from the query media item; and
determining that the reference fingerprint matches the query fingerprint based on the comparing of the one or more sub-fingerprints of only the non-silent segments to the one or more sub-fingerprints generated from the query media item.

A seventh embodiment provides a method according to the sixth embodiment wherein:

the comparing of the reference fingerprint to the query fingerprint omits any comparisons of the sub-fingerprint of the silent segment to any sub-fingerprints generated from the query media item.

An eighth embodiment provides a method according to any of the first through seventh embodiments, wherein:

the audio data included in the media item is reference audio data included in a reference media item, the silent segment is a reference silent segment, the non-silent segments are reference non-silent segments, the fingerprint is a reference fingerprint, the sub-fingerprint of the silent segment is a reference sub-fingerprint of the reference silent segment, and the sub-fingerprints of the non-silent segments are reference sub-fingerprints of the reference non-silent segments; and the method further comprises:
receiving a query fingerprint of query audio data included in a query media item to be identified;
selecting the reference fingerprint as a candidate fingerprint for comparison to the query fingerprint, the selecting being based on an index resultant from the indexing of the generated sub-fingerprints of the non-silent segments of the reference audio data;
determining that the selected reference fingerprint matches the received query fingerprint; and
identifying the query media item based on the determining that the selected reference fingerprint matches the received query fingerprint.

A ninth embodiment provides a method according to the eighth embodiment, wherein:

the receiving of the query fingerprint includes receiving a query sub-fingerprint of a query silent segment of the query audio data;
the method further comprises comparing the reference sub-fingerprint of the reference silent segment to the query sub-fingerprint of the query silent segment; and
the determining that the selected reference fingerprint matches the received query fingerprint is based on the comparing of the reference sub-fingerprint of the reference silent segment to the query sub-fingerprint of the query silent segment.

A tenth embodiment provides a method according to the ninth embodiment, wherein:

the receiving of the query fingerprint includes receiving query sub-fingerprints of query non-silent segments of the query audio data;
the method further comprises:
comparing one or more of the reference sub-fingerprints of the reference non-silent segments to one or more of the query sub-fingerprints of the query non-silent segments; and
determining that the comparing failed to find a match between the one or more of the reference sub-fingerprints of the reference non-silent segments and the one or more of the query sub-fingerprints of the query non-silent segments; and
the comparing of the reference sub-fingerprint of the reference silent segment to the query sub-fingerprint of the query sound segment is in response to the determining that the comparing failed to find the match.

An eleventh embodiment provides a method according to the eighth embodiment, wherein:

the receiving of the query fingerprint includes receiving a query sub-fingerprint of a query silent segment of the query audio data and receiving query sub-fingerprints of query non-silent segments of the query audio data;
the method further comprises:
calculating a percentage of query silent segments in the query audio data; and
determining that the percentage of query silent segments transgresses a predetermined threshold percentage of silent segments; and
the determining that the selected reference fingerprint matches the received query fingerprint is based on the calculated percentage of query silent segments transgressing the predetermined threshold percentage.

A twelfth embodiment provides a method according to the eleventh embodiment, wherein:

the predetermined threshold percentage of query silent segments is a maximum percentage of silent segments; and

In response to the calculated percentage of query silent segments exceeding the maximum percentage, the determining that the selected reference fingerprint matches the received query fingerprint includes determining that the calculated percentage of query silent segments matches a reference percentage of reference silent segments in the reference audio data.

A thirteenth embodiment provides a method according to the eleventh embodiment, wherein:

the predetermined threshold percentage of query silent segments is a maximum percentage of silent segments; and
in response to the calculated percentage of query silent segments exceeding the maximum percentage, the determining that the selected reference fingerprint matches the received query fingerprint includes determining that a reference sub-fingerprint among the reference sub-fingerprints of the reference non-silent segments matches a query sub-fingerprint among the query sub-fingerprints of the query non-silent segments.

A fourteenth embodiment provides a method according to the eleventh embodiment, wherein:

the predetermined threshold percentage of query silent segments is a minimum percentage of silent segments; and
in response to the calculated percentage of query silent segments failing to exceed the minimum percentage, the determining that the selected reference fingerprint matches the received query fingerprint includes determining that the calculated percentage of query silent segments matches a reference percentage of reference silent segments in the reference audio data.

A fifteenth embodiment provides a method according to the eleventh embodiment, wherein:

the predetermined threshold percentage of query silent segments is a minimum percentage of silent segments; and
in response to the calculated percentage of query silent segments failing to exceed the minimum percentage, the determining that the selected reference fingerprint matches the received query fingerprint includes determining that a reference sub-fingerprint among the reference sub-fingerprints of the reference non-silent segments matches a query sub-fingerprint among the query sub-fingerprints of the query non-silent segments.

A sixteenth embodiment provides a method according to any of the first through fifteenth embodiments, wherein:

the detecting of the silent segment is based on a threshold loudness and includes determining the threshold loudness by calculating a predetermined percentage of an average loudness of the multiple segments of the audio data.

A seventeenth embodiment provides a method according to any of the first through sixteenth embodiments, wherein:

the generating of the fingerprint of the media item includes storing each of the generated sub-fingerprints mapped to a different corresponding location of a different corresponding segment in the audio data.

An eighteenth embodiment provides a machine-readable medium (e.g., a non-transitory machine-readable storage medium) comprising instructions that, when executed by one or more hardware processors of a machine, cause the machine to perform operations comprising:

accessing audio data included in a media item;
detecting a silent segment among segments of the audio data, the segments of the audio data including non-silent segments in addition to the silent segment;
generating sub-fingerprints of the non-silent segments of the audio data by hashing the non-silent segments with a same fingerprinting algorithm;
generating a sub-fingerprint of the silent segment, the sub-fingerprint of the silent segment including a predetermined non-zero value that indicates fingerprinted silence;
generating a fingerprint of the media item by storing the generated sub-fingerprints mapped to locations of their corresponding segments in the audio data, the generated sub-fingerprint of the silent segment being mapped to a location of the silent segment in the audio data; and
indexing the fingerprint of the media item by indexing the generated sub-fingerprints of the non-silent segments of the audio data without indexing the generated sub-fingerprint of the silent segment of the audio data.

A nineteenth embodiment provides a system comprising:

one or more hardware processors; and
a memory storing instructions that, when executed by at least one hardware processor among the one or more hardware processors, cause the system to perform operations comprising:
accessing audio data included in a media item;
detecting a silent segment among segments of the audio data, the segments of the audio data including non-silent segments in addition to the silent segment;
generating sub-fingerprints of the non-silent segments of the audio data by hashing the non-silent segments with a same fingerprinting algorithm;
generating a sub-fingerprint of the silent segment, the sub-fingerprint of the silent segment including a predetermined non-zero value that indicates fingerprinted silence;
generating a fingerprint of the media item by storing the generated sub-fingerprints mapped to locations of their corresponding segments in the audio data, the generated sub-fingerprint of the silent segment being mapped to a location of the silent segment in the audio data; and
indexing the fingerprint of the media item by indexing the generated sub-fingerprints of the non-silent segments of the audio data without indexing the generated sub-fingerprint of the silent segment of the audio data.

A twentieth embodiment provides a system according to the nineteenth embodiment, wherein:

the indexing of the fingerprint of the media item indexes only the generated sub-fingerprints of the non-silent segments and omits the generated sub-fingerprint of the silent segment from the indexing.

A twenty-first embodiment provides a method comprising:

accessing, by one or more hardware processors, audio data included in a media item, the audio data including segments of the audio data, the segments including a silent segment and non-silent segments;
identifying, by the one or more hardware processors, the silent segment based on a comparison of a sound level of the silent segment to a reference sound level;
for each of the segments (e.g., the silent and non-silent segments), generating, by the one or more hardware processors, a sub-fingerprint of the segment, the generated sub-fingerprint of the silent segment including a predetermined non-zero value that indicates fingerprinted silence;
generating, by the one or more hardware processors, a fingerprint of the audio data, the fingerprint including the sub-fingerprints of the non-silent segments of the audio data and the sub-fingerprint of the silent segment of the audio data;
indexing, by the one or more hardware processors, the fingerprint of the audio data by indexing the sub-fingerprints of the non-silent segments of the audio data without indexing the sub-fingerprint of the silent segment of the audio data; and
storing, by the one or more hardware processors, the indexed fingerprint of the audio data in a database.

A twenty-second embodiment provides a machine-readable medium (e.g., a non-transitory machine-readable storage medium) comprising instructions that, when executed by one or more hardware processors of a machine, cause the machine to perform operations comprising:

accessing audio data included in a media item, the audio data including segments of the audio data, the segments including a silent segment and non-silent segments;
identifying the silent segment based on a comparison of a sound level of the silent segment to a reference sound level;
for each of the segments (e.g., the silent and non-silent segments), generating a sub-fingerprint of the segment, the generated sub-fingerprint of the silent segment including a predetermined non-zero value that indicates fingerprinted silence;
generating a fingerprint of the audio data, the fingerprint including the sub-fingerprints of the non-silent segments of the audio data and the sub-fingerprint of the silent segment of the audio data;
indexing the fingerprint of the audio data by indexing the sub-fingerprints of the non-silent segments of the audio data without indexing the sub-fingerprint of the silent segment of the audio data; and
storing the indexed fingerprint of the audio data in a database.

A twenty-third embodiment provides a system comprising:

one or more hardware processors; and
a memory storing instructions that, when executed by at least one hardware processor among the one or more hardware processors, cause the system to perform operations comprising:
accessing audio data included in a media item, the audio data including segments of the audio data, the segments including a silent segment and non-silent segments;
identifying the silent segment based on a comparison of a sound level of the silent segment to a reference sound level;
for each of the segments (e.g., the silent and non-silent segments), generating a sub-fingerprint of the segment, the generated sub-fingerprint of the silent segment including a predetermined non-zero value that indicates fingerprinted silence;
generating a fingerprint of the audio data, the fingerprint including the sub-fingerprints of the non-silent segments of the audio data and the sub-fingerprint of the silent segment of the audio data;
indexing the fingerprint of the audio data by indexing the sub-fingerprints of the non-silent segments of the audio data without indexing the sub-fingerprint of the silent segment of the audio data; and
storing the indexed fingerprint of the audio data in a database.

A twenty-fourth embodiment provides a method comprising:

generating, by one or more hardware processors, a query fingerprint of query audio data included in a query media item to be identified, the generated query fingerprint including a query sub-fingerprint of a query silent segment of the query audio data and query sub-fingerprints of query non-silent segments of the query audio data;
accessing (e.g., querying), by the one or more hardware processors, a database that stores a reference fingerprint of a reference media item (e.g., among a plurality of reference fingerprints of a plurality of reference media items), the database including an index in which reference sub-fingerprints of reference non-silent segments of reference audio data of a reference media item are indexed and in which a reference sub-fingerprint of a reference silent segment of the reference audio data is not indexed;
selecting, by the one or more hardware processors, the reference fingerprint as a candidate fingerprint for comparison to the query fingerprint, the selecting being based on the index in which reference sub-fingerprints of reference non-silent segments of reference audio data of the reference media item are indexed and in which a reference sub-fingerprint of a reference silent segment of the reference audio data is not indexed; and
identifying, by the one or more hardware processors, the query media item based on a comparison of the selected reference fingerprint to the received query fingerprint.

A twenty-fifth embodiment provides a system comprising:

one or more hardware processors; and
a memory storing instructions that, when executed by at least one hardware processor among the one or more hardware processors, cause the system to perform operations comprising:
generating a query fingerprint of query audio data included in a query media item to be identified, the generated query fingerprint including a query sub-fingerprint of a query silent segment of the query audio data and query sub-fingerprints of query non-silent segments of the query audio data;
accessing (e.g., querying) a database that stores a reference fingerprint of a reference media item (e.g., among a plurality of reference fingerprints of a plurality of reference media items), the database including an index in which reference sub-fingerprints of reference non-silent segments of reference audio data of a reference media item are indexed and in which a reference sub-fingerprint of a reference silent segment of the reference audio data is not indexed;
selecting the reference fingerprint as a candidate fingerprint for comparison to the query fingerprint, the selecting being based on the index in which reference sub-fingerprints of reference non-silent segments of reference audio data of the reference media item are indexed and in which a reference sub-fingerprint of a reference silent segment of the reference audio data is not indexed; and
identifying the query media item based on a comparison of the selected reference fingerprint to the received query fingerprint.

A twenty-sixth embodiment provides a machine-readable medium (e.g., a non-transitory machine-readable storage medium) comprising instructions that, when executed by one or more hardware processors of a machine, cause the machine to perform operations comprising:

generating a query fingerprint of query audio data included in a query media item to be identified, the generated query fingerprint including a query sub-fingerprint of a query silent segment of the query audio data and query sub-fingerprints of query non-silent segments of the query audio data;
accessing (e.g., querying) a database that stores a reference fingerprint of a reference media item (e.g., among a plurality of reference fingerprints of a plurality of reference media items), the database including an index in which reference sub-fingerprints of reference non-silent segments of reference audio data of a reference media item are indexed and in which a reference sub-fingerprint of a reference silent segment of the reference audio data is not indexed;
selecting the reference fingerprint as a candidate fingerprint for comparison to the query fingerprint, the selecting being based on the index in which reference sub-fingerprints of reference non-silent segments of reference audio data of the reference media item are indexed and in which a reference sub-fingerprint of a reference silent segment of the reference audio data is not indexed; and
identifying the query media item based on a comparison of the selected reference fingerprint to the received query fingerprint.

A twenty-seventh embodiment provides a carrier medium carrying machine-readable instructions for controlling a machine to carry out the method (e.g., operations) of any one of the previously described embodiments.

What is claimed is:

1. A method comprising:
accessing, by one or more hardware processors, audio data included in a media item, the audio data including segments, the segments including a silent segment and non-silent segments;
identifying, by the one or more hardware processors, the silent segment based on a comparison of a sound level of the silent segment to a reference sound level;
for each of the segments, generating, by the one or more hardware processors, a sub-fingerprint of the segment, the generated sub-fingerprint of the silent segment including a predetermined non-zero value that indicates fingerprinted silence;
generating, by the one or more hardware processors, a fingerprint of the audio data, the fingerprint including the sub-fingerprints of the non-silent segments of the audio data and the sub-fingerprint of the silent segment of the audio data;
indexing, by the one or more hardware processors, the fingerprint of the audio data by indexing the sub-fingerprints of the non-silent segments of the audio data without indexing the sub-fingerprint of the silent segment of the audio data; and
storing, by the one or more hardware processors, the indexed fingerprint of the audio data in a database.

2. The method of claim 1, wherein:
the indexing of the fingerprint of the audio data indexes only the generated sub-fingerprints of the non-silent segments and omits the generated sub-fingerprint of the silent segment from the indexing.

3. The method of claim 1, wherein:
the generating of the sub-fingerprints of the non-silent segments is based on a hashing algorithm; and
the generating of the sub-fingerprint of the silent segment includes:
hashing the silent segment with the hashing algorithm used to hash the non-silent segments, the hashing of the silent segment resulting in an output value; and
replacing the output value from the hashing of the silent segment with the predetermined non-zero value that indicates fingerprinted silence.

4. The method of claim 3, wherein:
the replacing of the output value with the predetermined non-zero value replaces the output value with one or more repetitions of a predetermined string of non-zero digits, the predetermined string of non-zero digits representing fingerprinted silence.

5. The method of claim 4, wherein:
the replacing of the output value with the predetermined non-zero value includes run-length encoding the one or more repetitions of the predetermined string of non-zero digits.

6. The method of claim 1, wherein:
the indexed fingerprint of the audio data is a reference fingerprint of a reference media item; and the method further comprises:
comparing the reference fingerprint to a query fingerprint of a query media item by comparing one or more sub-fingerprints of only the non-silent segments to one or more sub-fingerprints generated from the query media item; and
determining that the reference fingerprint matches the query fingerprint based on the comparing of the one or more sub-fingerprints of only the non-silent segments to the one or more sub-fingerprints generated from the query media item.

7. The method of claim 6, wherein:
the comparing of the reference fingerprint to the query fingerprint omits any comparisons of the sub-fingerprint of the silent segment to any sub-fingerprints generated from the query media item.

8. The method of claim 1, wherein:
the audio data included in the media item is reference audio data included in a reference media item, the silent segment is a reference silent segment, the non-silent segments are reference non-silent segments, the indexed fingerprint is a reference fingerprint of the reference media item, the sub-fingerprint of the silent segment is a reference sub-fingerprint of the reference silent segment, and the sub-fingerprints of the non-silent segments are reference sub-fingerprints of the reference non-silent segments; and the method further comprises:
receiving a query fingerprint of query audio data included in a query media item to be identified;
accessing the database in which the reference sub-fingerprints of the reference non-silent segments are indexed and in which the reference sub-fingerprint of the reference silent segment is not indexed;
selecting, from the database, the reference fingerprint as a candidate fingerprint for comparison to the query fingerprint; and
identifying the query media item based on a comparison of the selected reference fingerprint to the received query fingerprint.

9. The method of claim 8, wherein:
the receiving of the query fingerprint includes receiving a query sub-fingerprint of a query silent segment of the query audio data; and
the identifying of the query media item includes comparing the reference sub-fingerprint of the reference silent segment to the query sub-fingerprint of the query silent segment.

10. The method of claim 9, wherein:
the receiving of the query fingerprint includes receiving query sub-fingerprints of query non-silent segments of the query audio data;
the method further comprises:
comparing one or more of the reference sub-fingerprints of the reference non-silent segments to one or more of the query sub-fingerprints of the query non-silent segments; and
failing to find a match between the one or more of the reference sub-fingerprints of the reference non-silent segments and the one or more of the query sub-fingerprints of the query non-silent segments; and
in the identifying of the query media item, the comparing of the reference sub-fingerprint of the reference silent segment to the query sub-fingerprint of the query silent segment is in response to the failing to find the match.

11. The method of claim 8, wherein:
the receiving of the query fingerprint includes receiving a query sub-fingerprint of a query silent segment of the query audio data and receiving query sub-fingerprints of query non-silent segments of the query audio data;
the method further comprises:
calculating a percentage of query silent segments in the query audio data; and
determining that the percentage of query silent segments transgresses a predetermined threshold percentage of silent segments; and
the identifying of the query media item is based on the calculated percentage of query silent segments transgressing the predetermined threshold percentage of silent segments.

12. The method of claim 11, wherein:
the predetermined threshold percentage of query silent segments is a maximum percentage of silent segments; and
in response to the calculated percentage of query silent segments exceeding the maximum percentage, the identifying of the query media item includes comparing the calculated percentage of query silent segments to a reference percentage of reference silent segments in the reference audio data.

13. The method of claim 11, wherein:
the predetermined threshold percentage of query silent segments is a maximum percentage of silent segments; and
in response to the calculated percentage of query silent segments exceeding the maximum percentage, the identifying of the query media item includes determining that a reference sub-fingerprint among the reference sub-fingerprints of the reference non-silent segments matches a query sub-fingerprint among the query sub-fingerprints of the query non-silent segments.

14. The method of claim 11, wherein:
the predetermined threshold percentage of query silent segments is a minimum percentage of silent segments; and
in response to the calculated percentage of query silent segments failing to exceed the minimum percentage, the identifying of the query media item includes determining that the calculated percentage of query silent segments matches a reference percentage of reference silent segments in the reference audio data.

15. The method of claim 11, wherein:
the predetermined threshold percentage of query silent segments is a minimum percentage of silent segments; and
in response to the calculated percentage of query silent segments failing to exceed the minimum percentage, the identifying of the query media item includes determining that a reference sub-fingerprint among the reference sub-fingerprints of the reference non-silent segments matches a query sub-fingerprint among the query sub-fingerprints of the query non-silent segments.

16. The method of claim 1, wherein:
the identifying of the silent segment is based on a threshold loudness and includes determining the threshold loudness by calculating a predetermined percentage of an average loudness of the segments of the audio data.

17. The method of claim 1, wherein:
the generating of the fingerprint of the audio data includes mapping each of the generated sub-fingerprints to a different corresponding location of a different corresponding segment of the audio data.

18. A non-transitory machine-readable storage medium comprising instructions that, when executed by one or more hardware processors of a machine, cause the machine to perform operations comprising:
accessing audio data included in a media item, the audio data including segments of the audio data, the segments including a silent segment and non-silent segments;
identifying the silent segment based on a comparison of a sound level of the silent segment to a reference sound level;
for each of the segments, generating a sub-fingerprint of the segment, the generated sub-fingerprint of the silent segment including a predetermined non-zero value that indicates fingerprinted silence;
generating a fingerprint of the audio data, the fingerprint including the sub-fingerprints of the non-silent segments of the audio data and the sub-fingerprint of the silent segment of the audio data;
indexing the fingerprint of the audio data by indexing the sub-fingerprints of the non-silent segments of the audio data without indexing the sub-fingerprint of the silent segment of the audio data; and
storing the indexed fingerprint of the audio data in a database.

19. A system comprising:
one or more hardware processors; and
a memory storing instructions that, when executed by at least one hardware processor among the one or more hardware processors, cause the system to perform operations comprising:
accessing audio data included in a media item, the audio data including segments of the audio data, the segments including a silent segment and non-silent segments;
identifying the silent segment based on a comparison of a sound level of the silent segment to a reference sound level;
for each of the segments, generating a sub-fingerprint of the segment, the generated sub-fingerprint of the silent segment including a predetermined non-zero value that indicates fingerprinted silence;
generating a fingerprint of the audio data, the fingerprint including the sub-fingerprints of the non-silent segments of the audio data and the sub-fingerprint of the silent segment of the audio data;
indexing the fingerprint of the audio data by indexing the sub-fingerprints of the non-silent segments of the audio data without indexing the sub-fingerprint of the silent segment of the audio data; and
storing the indexed fingerprint of the audio data in a database.

20. The system of claim 19, wherein:
the indexing of the fingerprint of the audio data indexes only the generated sub-fingerprints of the non-silent segments and omits the generated sub-fingerprint of the silent segment from the indexing.

21. A method comprising:
generating, by one or more hardware processors, a query fingerprint of query audio data included in a query media item to be identified, the generated query fingerprint including a query sub-fingerprint of a query silent segment of the query audio data and query sub-fingerprints of query non-silent segments of the query audio data;
querying, by the one or more hardware processors, a database that stores a plurality of reference fingerprints of a plurality of reference media items, a reference fingerprint among the plurality of reference fingerprints identifying a reference media item, the database including an index in which reference sub-fingerprints of reference non-silent segments of reference audio data of the reference media item are indexed and in which a reference sub-fingerprint of a reference silent segment of the reference audio data is not indexed;
selecting, by the one or more hardware processors, the reference fingerprint as a candidate fingerprint for comparison to the query fingerprint, the selecting being based on the index in which the reference sub-fingerprints of the reference non-silent segments are indexed and in which the reference sub-fingerprint of the reference silent segment is not indexed; and
identifying, by the one or more hardware processors, the query media item based on a comparison of the selected reference fingerprint to the received query fingerprint.

22. A system comprising:
one or more hardware processors; and
a memory storing instructions that, when executed by at least one hardware processor among the one or more hardware processors, cause the system to perform operations comprising:
generating a query fingerprint of query audio data included in a query media item to be identified, the generated query fingerprint including a query sub-fingerprint of a query silent segment of the query audio data and query sub-fingerprints of query non-silent segments of the query audio data;
querying a database that stores a plurality of reference fingerprints of a plurality of reference media items, a reference fingerprint among the plurality of reference fingerprints identifying a reference media item, the database including an index in which reference sub-fingerprints of reference non-silent segments of reference audio data of the reference media item are indexed and in which a reference sub-fingerprint of a reference silent segment of the reference audio data is not indexed;
selecting the reference fingerprint as a candidate fingerprint for comparison to the query fingerprint, the selecting being based on the index in which the reference sub-fingerprints of the reference non-silent segments are indexed and in which the reference sub-fingerprint of the reference silent segment is not indexed; and
identifying the query media item based on a comparison of the selected reference fingerprint to the received query fingerprint.

23. A non-transitory machine-readable storage medium comprising instructions that, when executed by one or more hardware processors of a machine, cause the machine to perform operations comprising:
generating a query fingerprint of query audio data included in a query media item to be identified, the generated query fingerprint including a query sub-fingerprint of a query silent segment of the query audio data and query sub-fingerprints of query non-silent segments of the query audio data;
querying a database that stores a plurality of reference fingerprints of a plurality of reference media items, a reference fingerprint among the plurality of reference fingerprints identifying a reference media item, the database including an index in which reference sub-fingerprints of reference non-silent segments of reference audio data of the reference media item are indexed and in which a reference sub-fingerprint of a reference silent segment of the reference audio data is not indexed;
selecting the reference fingerprint as a candidate fingerprint for comparison to the query fingerprint, the selecting being based on the index in which the reference sub-fingerprints of the reference non-silent segments are indexed and in which the reference sub-fingerprint of the reference silent segment is not indexed; and
identifying the query media item based on a comparison of the selected reference fingerprint to the received query fingerprint.
